(19) United States
(12) Patent Application Publication
(10) Pub. No.: US 2025/0133600 A1
(43) Pub. Date: Apr. 24, 2025

(54) WIRELESS COMMUNICATION METHOD AND APPARATUS

(71) Applicant: GUANGDONG OPPO MOBILE TELECOMMUNICATIONS CORP., LTD., Dongguan (CN)

(72) Inventor: Chuanfeng HE, Dongguan (CN)

(21) Appl. No.: 19/001,133

(22) Filed: Dec. 24, 2024

Related U.S. Application Data
(63) Continuation of application No. PCT/CN2022/110629, filed on Aug. 5, 2022.

(51) Int. Cl. H04W 74/0833; H04W 52/36

(52) U.S. Cl. CPC H04W 74/0833; H04W 52/367

(57) ABSTRACT

Provided are a wireless communication method and an apparatus. The method includes: if a transmission parameter corresponding to first-type PRACH transmission meets a condition, performing, by a terminal device, second-type PRACH transmission, where one transmission process of the first-type PRACH transmission includes one PRACH transmission, and one transmission process of the second-type PRACH transmission includes a plurality of PRACH transmissions.

### CROSS-REFERENCE TO RELATED APPLICATIONS

This application is a continuation of International Application No. PCT/CN2022/110629, filed on Aug. 5, 2022, the disclosure of which is hereby incorporated by reference in its entirety.

### TECHNICAL FIELD

This application relates to the field of communication technologies, and more specifically, to a wireless communication method and an apparatus.

### BACKGROUND

During a random access procedure, a terminal device needs to transmit a physical random access channel (PRACH) to a network device. There are currently two types of PRACH transmission modes, and there is no clear approach to combine these two PRACH transmission modes.

### SUMMARY

This application provides a wireless communication method and an apparatus. The following describes various aspects involved in this application.

According to a first aspect, a wireless communication method is provided, including: if a transmission parameter corresponding to first-type PRACH transmission meets a condition, performing, by a terminal device, second-type PRACH transmission, where one transmission process of the first-type PRACH transmission includes one PRACH transmission, and one transmission process of the second-type PRACH transmission includes a plurality of PRACH transmissions.

According to a second aspect, a wireless communication method is provided, including: if a transmission parameter corresponding to first-type PRACH transmission meets a condition, receiving, by a network device, a PRACH transmitted by using a manner of second-type PRACH transmission, where one transmission process of the first-type PRACH transmission includes one PRACH transmission, and one transmission process of the second-type PRACH transmission includes a plurality of PRACH transmissions.

According to a third aspect, a terminal device is provided, including: a transmission unit, configured to: if a transmission parameter corresponding to first-type physical random access channel PRACH transmission meets a condition, perform second-type PRACH transmission, where one transmission process of the first-type PRACH transmission includes one PRACH transmission, and one transmission process of the second-type PRACH transmission includes a plurality of PRACH transmissions.

According to a fourth aspect, a network device is provided, including: a receiving unit, configured to: if a transmission parameter corresponding to first-type physical random access channel PRACH transmission meets a condition, receive a PRACH transmitted by using a manner of second-type PRACH transmission, where one transmission process of the first-type PRACH transmission includes one PRACH transmission, and one transmission process of the second-type PRACH transmission includes a plurality of PRACH transmissions.

According to a fifth aspect, a terminal device is provided, including a processor, a memory, and a communication interface. The memory is configured to store one or more computer programs, and the processor is configured to invoke the computer program in the memory to cause the terminal device to perform some or all of the steps in the method according to the first aspect.

According to a sixth aspect, a network device is provided, including a processor, a memory, and a communication interface. The memory is configured to store one or more computer programs, and the processor is configured to invoke the computer program in the memory to cause the network device to perform some or all of the steps in the method according to the second aspect.

According to a seventh aspect, an embodiment of this application provides a communication system, and the system includes the terminal and/or network device described above. In another possible design, the system may further include another device interacting with the terminal or network device in the solutions provided in embodiments of this application.

According to an eighth aspect, an embodiment of this application provides a computer-readable storage medium. The computer-readable storage medium stores a computer program that causes a terminal to perform some or all of the steps in the method according to the foregoing aspects.

According to a ninth aspect, an embodiment of this application provides a computer program product. The computer program product includes a non-transitory computer-readable storage medium storing a computer program, and the computer program is operable to cause a terminal to perform some or all of the steps of the method according to the foregoing aspects. In some implementations, the computer program product may be a software installation package.

According to a tenth aspect, an embodiment of this application provides a chip. The chip includes a memory and a processor, and the processor may invoke and run a computer program from the memory, to implement some or all of the steps of the method according to the foregoing aspects.

### BRIEF DESCRIPTION OF DRAWINGS

FIG. 1 shows a wireless communication system 100 to which an embodiment of this application is applied.

FIG. 2 is a schematic flowchart of a contention-based random access method.

FIG. 3 is a schematic flowchart of a non-contention based random access method.

FIG. 4 is a schematic diagram of second-type PRACH transmission according to an embodiment of this application.

FIG. 5 is a schematic flowchart of a wireless communication method according to an embodiment of this application.

FIG. 6 is a schematic diagram of performing PRACH transmission based on Condition 1 according to an embodiment of this application.

FIG. 7 is a schematic diagram of performing PRACH transmission based on Condition 2 according to an embodiment of this application.

FIG. 8 is a schematic diagram of performing PRACH transmission based on Condition 3 according to an embodiment of this application.

FIG. 9 is a schematic diagram of counting two types of PRACH transmission together according to an embodiment of this application.

FIG. 10 is a schematic diagram of counting two types of PRACH transmission separately according to an embodiment of this application.

FIG. 11 is a schematic block diagram of a terminal device according to an embodiment of this application.

FIG. 12 is a schematic block diagram of a network device according to an embodiment of this application.

FIG. 13 is a schematic diagram of a structure of a communication apparatus according to an embodiment of this application.

### DESCRIPTION OF EMBODIMENTS

The following describes technical solutions in this application with reference to the accompanying drawings.

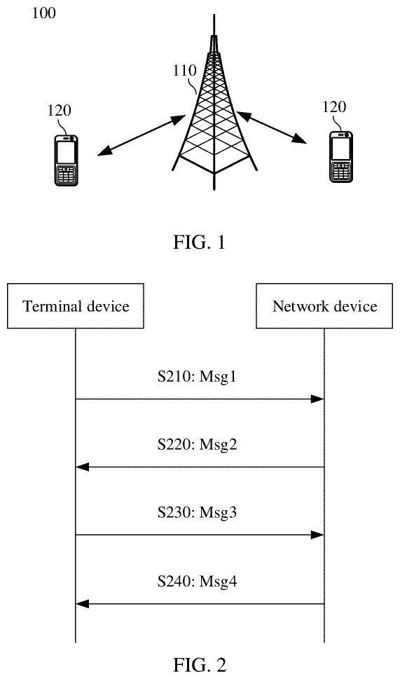

FIG. 1 shows a wireless communication system 100 to which an embodiment of this application is applied. The wireless communication system 100 may include a network device 110 and a terminal device 120. The network device 110 may be a device in communication with the terminal device 120. Each network device 110 may provide communication coverage for a specific geographic area, and may communicate with a terminal device 120 located within the coverage.

FIG. 1 exemplarily shows one network device and two terminals. Optionally, the wireless communication system 100 may include a plurality of network devices, and another quantity of terminal devices may be included in the coverage of each network device, which is not limited in this embodiment of this application.

Optionally, the wireless communication system 100 may further include other network entities such as a network controller and a mobility management entity, which is not limited in this embodiment of this application.

It should be understood that technical solutions of embodiments of this application may be applied to various communication systems, such as a 5th generation (5G) system or a new radio (NR) system, a long term evolution (LTE) system, an LTE frequency division duplex (FDD) system, and an LTE time division duplex (TDD) system. The technical solutions provided in this application may be further applied to a future communication system, such as a 6th generation mobile communication system or a satellite communication system.

The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communication device, a user agent, or a user apparatus. The terminal device in embodiments of this application may be a device providing a user with voice and/or data connectivity and capable of connecting people, objects, and machines, such as a handheld device or vehicle-mounted device having a wireless connection function. The terminal device in embodiments of this application may be a mobile phone (mobile phone), a tablet computer (pad), a notebook computer, a palmtop computer, a mobile Internet device (MID), a wearable device, a virtual reality (VR) device, an augmented reality (AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart household device communicate with each other, without the relay of a communication signal through a base station.

The network device in embodiments of this application may be a device for communicating with the terminal device. The network device may also be referred to as an access network device or a wireless access network device. For example, the network device may be a base station. The network device in embodiments of this application may be a radio access network (radio access network, RAN) node (or device) that connects the terminal device to a wireless network. The base station may broadly cover the following various names, or may be interchanged with the following names, such as a NodeB, an evolved NodeB (eNB), a next generation NodeB (gNB), a relay station, an access point, a transmitting and receiving point (TRP), a transmitting point (transmitting point, TP), a master eNode (MeNB), a secondary eNode (SeNB), a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. Alternatively, the base station may be a communication module, a modem, or a chip disposed in the device or apparatus described above. Alternatively, the base station may be a mobile switching center, a device that serves as a base station in device-to-device D2D, vehicle-to-everything (V2X), and machine-to-machine (M2M) communications, a network-side device in a 6G network, a device that serves as a base station in a future communication system, or the like. The base station may support networks with a same access technology or different access technologies. A specific technology and a specific device used by the network device are not limited in embodiments of this application.

The base station may be a fixed or mobile base station. For example, a helicopter or an unmanned aerial vehicle may be configured to function as a mobile base station, and one or more cells may move according to a position of the mobile base station. In another example, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or in-vehicle, may be deployed on a water surface, or may be deployed on a plane, a balloon, or a satellite in the air. In embodiments of this application, a scenario in which the network device and the terminal device are located is not limited.

It should be understood that all or some of the functions of the communication device in this application may also be implemented by software running on hardware, or by virtualization functions instantiated on a platform (such as a cloud platform).

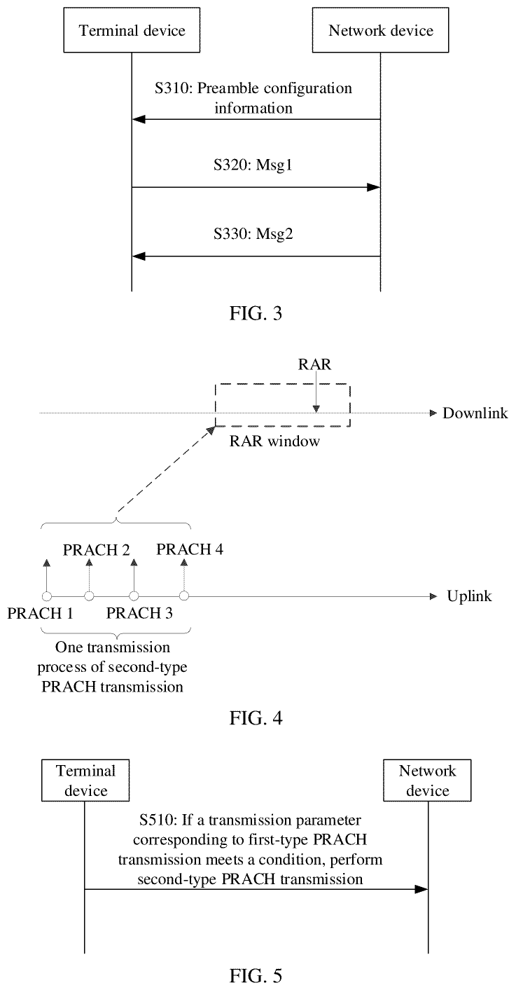

The terminal device may achieve uplink synchronization through random access. There are two random access modes: contention-based random access and non-contention based random access. The two random access modes are described below with reference to FIG. 2 and FIG. 3.

FIG. 2 is a flowchart of a contention-based random access method according to an embodiment of this application. The method includes step S210 to step S240.

In step S210, a terminal device sends a message 1 (Msg1) in a random access procedure to a network device, where the message 1 includes a preamble (preamble).

The terminal device may select a PRACH resource and a preamble, and send the selected preamble on the selected resource. The PRACH resource may also be referred to as a RACH resource.

The network device may send configuration information of the PRACH resource to the terminal device in a form of broadcast. The configuration information of the PRACH resource may be used to determine time domain information, frequency domain information, and code domain information of the PRACH resource.

The configuration information of the PRACH resource includes one or more of the following information: a preamble format (preamble format), a repetition period of PRACH resources, a radio frame offset, a subframe number in a radio frame, a start symbol in a subframe, a quantity of PRACH slots in a subframe, a quantity of PRACH occasions (RACH occasions, RO) in a PRACH slot, or duration of a PRACH occasion. Based on the configuration information of the PRACH resource, the terminal device can determine the time domain information, the frequency domain information, and the code domain information of the PRACH resource.

The configuration information of the PRACH resource may be carried in a system message, that is, the network device may send configuration information of a RACH through a system message. In addition, the system message may further indicate an association between a synchronization signal block (SSB) and a PRACH resource. The terminal device may determine available PRACH resources, such as PRACH occasion and a preamble, based on a detected SSB and the association. In some embodiments, the network device may control selection of a random access resource by the terminal device by configuring a reference signal received power (RSRP) threshold. The terminal device can select, based on an SSB measurement result, an SSB whose RSRP measurement value meets the RSRP threshold, and send a preamble by using a PRACH resource associated with the SSB.

In step S220, the network device sends a Msg2 to the terminal device, where the Msg2 may also be referred to as a random access response (RAR). The Msg2 may be carried through a physical downlink control channel (PDCCH).

After sending the Msg1, the terminal device may start a RAR time window and monitor a PDCCH scrambled by a random access-radio network temporary identifier (RA-RNTI) within the RAR time window. The RA-RNTI is related to a time-frequency resource of a RACH used by the terminal device for sending the Msg1. After receiving a PDCCH, the terminal device may decode the PDCCH by using the RA-RNTI.

The Msg2 may further include a preamble sent by the terminal device. If the terminal device receives a PDCCH scrambled by an RA-RNTI and the Msg2 includes the preamble sent by the terminal device, the terminal device may determine that the random access response has been successfully received.

After the terminal device successfully receives the PDCCH, the terminal device can obtain a physical downlink shared channel (PDSCH) scheduled by the PDCCH, where the PDSCH includes the RAR. The RAR may include a plurality of pieces of information. For example, a subheader (subheader) in the RAR may include a backoff indicator (BI), and the BI may be used to indicate a backoff time for retransmitting the Msg1; a random access preamble identifier (RAPID) in the RAR indicates a preamble index received by the network device; a payload (payload) in the RAR may include a timing advance group (TAG), and the TAG may be used to adjust uplink timing; the RAR may further include an uplink grant (UL grant) used for scheduling an uplink resource indication for the Msg3; the RAR may further include a temporary cell-radio network temporary identifier (C-RNTI). A terminal device that performs initial access may decode a PDCCH of a Msg4 by using use the temporary C-RNTI.

In step S230, the terminal device sends a Msg3 to the network device. The terminal device may send the Msg3 on an uplink grant scheduled by the network device. The Msg3 may also be referred to as a radio resource control (RRC) connection establishment request message.

The Msg3 is mainly used to inform the network device of an event that triggers the random access procedure. For example, in the case of an initial access random procedure, the terminal device may add a UE identity (ID) and an establishment cause (establishment cause) to the Msg3. In the case of RRC re-establishment, the terminal device may add a UE identity in a connected state and an establishment cause to the Msg3.

In step S240, the network device sends a Msg4 to the terminal device. The Msg4 may also be referred to as a conflict resolution message.

The Msg4 has two functions: one is used for contention conflict resolution, and the other is used for transmitting an RRC configuration message to the terminal device. If the terminal device has added a C-RNTI to the Msg3, Msg4 is scheduled by using a PDCCH scrambled by the C-RNTI. Accordingly, the terminal device may decode the PDCCH to obtain the Msg4 by using the C-RNTI in the Msg3. If the terminal device has not added a C-RNTI to the Msg3, for example, in the case of initial access, the Msg4 may be scheduled by using a PDCCH scrambled by a temporary C-RNTI. Accordingly, the terminal device may decode the PDCCH to obtain the Msg4 by using the temporary C-RNTI in the Msg2. After successfully decoding the PDCCH, the terminal device obtains a PDSCH that carries the Msg4. The terminal device may compare a common control channel (CCCH) service data unit (SDU) in the PDSCH with a CCCH SDU in the Msg3. If the two SDUs are the same, it indicates that the contention resolution is successful.

FIG. 3 is a flowchart of a non-contention based random access method according to an embodiment of this application. The method includes step S310 to step S330.

In step S310, a network device sends preamble configuration information to a terminal device, where the configuration information includes a preamble and a RACH resource required in a random access procedure.

In step S320, the terminal device sends a Msg1 to the network device based on the preamble configuration information, that is, the terminal device sends the preamble to the network device on the RACH resource.

In step S330, the network device sends a Msg2 to the terminal device, where the Msg2 may include a RAR. When the RAR is received by the terminal device, it indicates that the random access procedure ends.

Each time after the terminal device transmits a preamble, the terminal device detects a RAR within a RAR window. If the RAR transmitted by the network device has not been received within the RAR window, or the terminal device has not received a Msg4, the terminal device needs to retransmit a PRACH, that is, the terminal device may trasnmit a preamble again on a next available PRACH resource. This process is also referred to as PRACH retransmission (re-transmission). The following describes PRACH retransmission by using an example in which the terminal device has not received the RAR transmitted by the network device.

It should be noted that the random access procedure of the terminal device may include a plurality of PRACH transmissions. In embodiments of this application, the 1st PRACH transmission in the random access procedure may be referred to as the initial PRACH transmission, and subsequent PRACH transmission may be referred to as PRACH retransmission.

In order to improve PRACH coverage, a power of the terminal device for transmitting a preamble increases by one step based on a previous transmit power. In a case that the terminal device supports a plurality of transmit beams and if the transmit beam remains unchanged, a transmit power of a retransmitted PRACH also increases based on a PRACH power transmitted previously. In this way, the terminal device can be prevented from transmitting by using more power than required, thereby reducing interference caused by transmitting a PRACH by the terminal device.

The following describes a manner of calculating a transmit power of a preamble.

PRACH power control is performed according to an open-loop power control mechanism. The terminal device may determine a PRACH transmit power based on factors such as an expected receive power configured by the network device and a path loss.

The PRACH transmit power P_{PRACH, b,f,c} (i) may be determined by using the following Formula (1):

$${P}_{PRACH , b , f , c} ( i ) = min \{ {P}_{C M A X , f , c} ( i ) , {P}_{PRACH , target , f , c} + P {L}_{b , f , c} \} \qquad ( Formula 1 )$$

P_{CMAX,f,c} (i) represents a maximum transmit power of the terminal device corresponding to a transmission occasion i on a carrier f in a serving cell c, PL_{b,f,c} represents a measured path loss, and P_{PRACH,target,f,c} represents a target received power PREAMBLE_RECEIVED_TARGET_POWER of a PRACH determined by a medium access control (MAC) layer. The path loss may be a path loss measured by the terminal device on the carrier f, for an active UL bandwidth part (BWP) b, based on a downlink (DL) reference signal (RS) associated with PRACH transmission in an active downlink BWP of the serving cell c. P_{PRACH,target,f,c}+PL_{b,f,c} is also referred to below as a power calculated by open-loop power control.

PREAMBLE_RECEIVED_TARGET_POWER may be determined based on the following Formula (2):

PREAMBLE_RECEIVED_TARGET_POWER=preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA (Formula 2)

preambleReceivedTargetPower represents a target PRACH received power configured by a higher layer, DELTA_PREAMBLE represents a compensation value, PREAMBLE_POWER_RAMPING_COUNTER represents a quantity of PRACH transmissions, PREAMBLE_POWER_RAMPING_STEP represents a power ramp-up step, and POWER_OFFSET_2STEP_RA represents an offset value.

After transmitting a PRACH to the network device, the terminal device detects, within a RAR window, a RAR transmitted by the network device. If the RAR transmitted by the network device has not been received, the terminal device retransmits the PRACH. A power of the RAR retransmitted by the terminal device may be increased according to Formula (1), and the terminal device may retransmit the PRACH by using the increased power.

For convenience of description, the foregoing PRACH transmission mode is referred to below as first-type PRACH transmission. It can be learned from the foregoing Formula (1) that a maximum transmit power of the first-type PRACH transmission is P_{CMAX,f,c} (i), that is, the PRACH transmit power cannot be increased indefinitely. When PRACH coverage is limited, the terminal device cannot increase the PRACH transmit power indefinitely to allow the network device to detect the PRACH. In order to improve PRACH coverage performance, second-type PRACH transmission is introduced into a protocol. The second-type PRACH transmission is also referred to as PRACH repetition (repetition).

Reference is made to FIG. 4. The second-type PRACH transmission may be understood as performing a plurality of PRACH transmissions in one transmission process by the terminal device, and the plurality of PRACH transmissions correspond to one RAR window. One transmission process shown in FIG. 4 includes four PRACH transmissions. The network device may receive the plurality of PRACHs in a combined manner to improve detection performance, thereby improving PRACH coverage.

It can be learned from the foregoing description that the prior art includes two PRACH transmission modes: first-type PRACH transmission and second-type PRACH transmission. Both transmission modes can improve PRACH coverage. There is currently no clear approach on how to combine these two transmission modes to improve PRACH coverage.

In view of this, an embodiment of this application provides a wireless communication method, which provides a definite combination approach of the two transmission modes. PRACH transmission in embodiments of this application includes two types: first-type PRACH transmission and second-type PRACH transmission. The first-type PRACH transmission and the second-type PRACH transmission use different transmission modes. For ease of understanding, these two types of PRACH transmission are first described.

The first-type PRACH transmission may be the PRACH retransmission mode described above. The first-type PRACH transmission may be understood as PRACH transmission performed in a first transmission mode. The first PRACH transmission may also be referred to as single transmission, separate transmission, or PRACH re-transmission. In some embodiments, one transmission process of the first-type PRACH transmission includes one PRACH transmission (or one PRACH). One transmission process may be understood as a process of performing PRACH transmission between two RAR windows. In some embodiments, one PRACH transmission in the first-type PRACH transmission corresponds to one RAR window. In other words, in the first-type PRACH transmission, one RAR window corresponds to one PRACH transmission, or one RAR window is associated with one PRACH transmission.

In some embodiments, during the first-type PRACH transmission, the terminal device may transmit a PRACH to the network device, and then detect a RAR transmitted by the network device in a RAR window. If the RAR transmitted by the network device has not been detected, the terminal device may transmit a PRACH again on a next available PRACH resource, and then detect a RAR on a RAR window corresponding to the PRACH, and so on. It can be learned from the foregoing description that, during the first-type PRACH transmission, each PRACH may correspond to an independent RAR window, that is, each time a PRACH transmission is performed, detection is performed on a corresponding RAR window.

The second-type PRACH transmission may be understood as PRACH transmission performed in a second transmission mode. The second transmission mode is different from the first transmission mode. The second-type PRACH transmission may also be referred to as PRACH repetition (repetition). In some embodiments, one transmission process of the second-type PRACH transmission may include a plurality of PRACH transmissions. One transmission process may be understood as a process of performing PRACH transmission between two RAR windows. In some embodiments, a plurality of PRACH transmissions in the second-type PRACH transmission correspond to one RAR window. In other words, in the second-type PRACH transmission, one RAR window corresponds to a plurality of PRACH transmissions, or one RAR window is associated with a plurality of PRACH transmissions. It should be noted that, in embodiments of this application, the plurality of PRACH transmissions are considered as one transmission as a whole.

In some embodiments, during the second-type PRACH transmission, the terminal device may transmit a plurality of PRACHs to the network device, and then detect, in a RAR window, a RAR transmitted by the network device. If the RAR transmitted by the network device has not been detected, the terminal device may transmit a plurality of PRACHs again on a next available PRACH resource, and then detect a RAR on a RAR window corresponding to the plurality of PRACHs, and so on. It can be learned from the foregoing description that, in a process of performing the second-type PRACH transmission, a plurality of PRACHs are mutually associated or bound with each other, and the plurality of PRACHs correspond to one RAR window.

A quantity of PRACHs included in one transmission process of the second-type PRACH transmission is not limited in embodiments of this application. For example, the quantity of PRACHs included in one transmission process may be any integer greater than 1, for example, is 2, 3, or 4. It may be understood that more PRACHs included in one transmission process indicate stronger PRACH coverage performance.

The quantity of PRACHs included in one transmission process may be predefined in a protocol or indicated by the network device, and this is not specifically limited in embodiments of this application.

In some embodiments, the network device may transmit a RAR to the terminal device after transmission of the plurality of PRACHs in one transmission process is completed, or may transmit a RAR to the terminal device after receiving a part of the plurality of PRACHs. For example, one PRACH transmission process may include four PRACH transmissions, and the network device may transmit a RAR to the terminal device after receiving one PRACH transmission, two PRACH transmissions, or three PRACH transmissions of the four PRACH transmissions. For example, if the network device can completely parse PRACH information after receiving the 1^{st} PRACH, the network device may not receive other PRACHs, and directly transmit a RAR to the terminal device after receiving the 1^{st} PRACH.

The following describes solutions of this embodiment of this application in detail with reference to FIG. 5.

Reference is made to FIG. 5. In step S510, if a transmission parameter corresponding to first-type PRACH transmission meets a condition, a terminal device may perform second-type PRACH transmission. That is, if the transmission parameter corresponding to the first-type PRACH transmission meets the condition, the terminal device may transmit, to a network device, a PRACH transmitted in the second-type PRACH transmission mode, that is, the network device may receive the PRACH transmitted in the second-type PRACH transmission mode and transmitted by the terminal device.

In this embodiment of this application, the terminal device may first perform first-type PRACH transmission, and then switch to second-type PRACH transmission when a condition is met. Because the first-type PRACH transmission requires fewer resources, performing the first-type PRACH transmission first can reduce resource occupation. The second-type PRACH transmission is performed when the first-type PRACH transmission meets the condition, to improve PRACH coverage.

In some embodiments, the transmission parameter may include any parameter related to PRACH transmission. For example, the transmission parameter may include one or more of the following: a transmit power, a quantity of transmissions, a downlink path loss, or the like. In other words, the condition may be associated with one or more of the following information: a transmit power corresponding to the first-type PRACH transmission, a quantity of transmissions corresponding to the first-type PRACH transmission, or a downlink path loss.

A larger PRACH transmit power indicates poorer coverage at a location of the terminal device, and indicates that a larger transmit power is required to meet a requirement of a target transmit power. Therefore, by determining the condition based on the transmit power, the terminal device can perform the second-type PRACH transmission in a case that the transmit power is relatively large, to improve PRACH coverage.

It can be learned from Formula (1) that more PRACH transmissions indicate a larger transmit power of the terminal device, and poorer coverage at the location of the terminal device. Therefore, by determining the condition based on the quantity of transmissions, the terminal device can perform the second-type PRACH transmission in a case that the quantity of transmissions is relatively large, to improve PRACH coverage.

If the downlink path loss measured by the terminal device is relatively large, it indicates that the coverage at the location of the terminal device is relatively poor. Therefore, by determining the condition based on the downlink path loss, the terminal device can perform the second-type PRACH transmission in a case that the coverage is relatively poor, to improve PRACH coverage.

The condition is not specifically limited in embodiments of this application. In an example, the condition may include: a transmit power corresponding to the first-type PRACH transmission reaches a maximum transmit power of the terminal device. In another example, the condition may include: a transmit power corresponding to the first-type PRACH transmission is greater than or equal to a first threshold. In still another example, the condition may include: a quantity of transmissions corresponding to the first-type PRACH transmission is greater than or equal to a second threshold.

It should be noted that, in this embodiment of this application, when the condition is met, the second-type PRACH transmission may be performed in a current transmission, or when the condition is met, the second-type PRACH transmission may be performed in a next transmission. For example, when the condition is met, the terminal device may still perform the first-type PRACH transmission in a current transmission, and switch to the second-type PRACH transmission in a next transmission when the condition is met.

The foregoing three conditions are separately described below.

### Condition 1: The Transmit Power Corresponding to the First-Type PRACH Transmission Reaches the Maximum Transmit Power of the Terminal Device

It can be learned from the foregoing description that a transmit power of a PRACH may be determined based on a target received power, a path loss, a quantity of PRACH power ramp-up times, and a step that are configured by a higher layer. For the terminal device, initial power of PRACH may be determined through open-loop power control, and then the power may be gradually increased so that the network device can eventually successfully detect a PRACH (or preamble) transmitted by the terminal device, thereby preventing transmission by using more power than required, and thus reducing interference caused by the terminal device.

For a terminal device with relatively poor coverage, a calculated path loss of the terminal device is relatively large, and the power calculated through open-loop power control may reach or exceed the maximum transmit power of the terminal device. This case may occur during the initial transmission of the PRACH or during retransmission of the terminal device. For example, during the initial transmission of the PRACH, an open-loop power calculated by the terminal device reaches or exceeds the maximum transmit power. For another example, during the initial transmission of the PRACH, the open-loop power calculated by the terminal device does not reach or exceed the maximum transmit power. However, during subsequent retransmission, the terminal device increases the power, and the increased power may reach or exceed the maximum transmit power.

According to the foregoing Formula (1), if the power determined based on the open-loop power control reaches or exceeds the maximum transmit power, the terminal device uses the maximum transmit power as the transmit power of the PRACH. A power of subsequent PRACH retransmission can no longer be increased, and only the maximum transmit power can be used for transmitting. In this case, the terminal device cannot improve PRACH coverage by increasing the PRACH transmit power.

In this embodiment of this application, the terminal device can perform the second-type PRACH transmission when the transmit power corresponding to the first-type PRACH transmission reaches the maximum transmit power, so that PRACH coverage can be further improved.

In some embodiments, before each PRACH transmission, the terminal device may first calculate a required power based on the first-type PRACH transmission (that is, Formula (1)), and compare the calculated power with the maximum transmit power. If the calculated power is less than the maximum transmit power, the first-type PRACH transmission is performed. If the calculated power is equal to the maximum transmit power, the second-type PRACH transmission is performed.

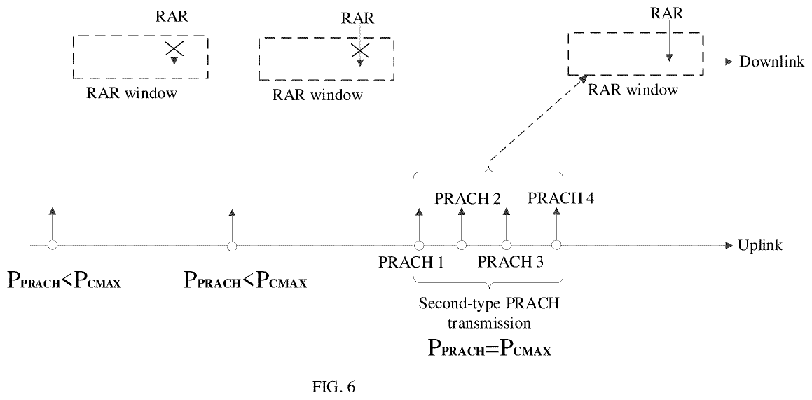

The following describes a PRACH transmission process with reference to FIG. 6.

When performing a 1^{st} PRACH transmission, the terminal device may first calculate the required transmit power according to Formula (1). Because the calculated transmit power is less than the maximum transmit power, the terminal device performs the first-type PRACH transmission. If the terminal device has not detected, in a RAR window corresponding to the 1^{st} PRACH transmission, a RAR transmitted by the network device, the terminal device performs a 2^{nd} PRACH transmission. The terminal device recalculates the transmit power according to Formula (1), that is, increases the transmit power of the PRACH. Because the calculated transmit power is less than the maximum transmit power, the terminal device performs the first-type PRACH transmission. If the terminal device has not detected, in a RAR window corresponding to the 2^{nd} PRACH transmission, a RAR transmitted by the network device, the terminal device performs a 3rd PRACH transmission. The terminal device recalculates the transmit power according to Formula (1), that is, increases the transmit power of the PRACH. Because the transmit power calculated for the third time is equal to the maximum transmit power, the condition for performing the second-type PRACH transmission is met, and the terminal device performs the second-type PRACH transmission. The terminal device may transmit a plurality of PRACHs during the 3^{rd} PRACH transmission. As shown in FIG. 6, the terminal device may transmit four PRACHs during the 3^{rd} PRACH transmission process. The four PRACHs correspond to one RAR window, and the terminal device may detect, in the RAR window, a RAR transmitted by the network device.

Condition 2: The Transmit Power Corresponding to the First-Type PRACH Transmission is Greater than or Equal to the First Threshold

In some embodiments, Condition 2 may also be: the transmit power corresponding to the first-type PRACH transmission reaches or satisfies the first threshold.

In this embodiment, if a power calculated by using open-loop power control is less than the maximum transmit power, the transmit power of the PRACH is equal to the power calculated by using open-loop power control. The solutions of this embodiment are mainly described below using the term “power calculated by using open-loop power control”.

It can be learned from the manner of calculating the power by using open-loop power control in the foregoing description that a downlink path loss is considered for a power of the PRACH, and the path loss also reflects a current coverage level of the terminal device. Therefore, it may be determined whether to perform the second-type PRACH transmission based on the path loss (a measurement result of a downlink signal). For example, it may be determined whether to perform the second-type PRACH transmission based on a path loss obtained by measuring a downlink reference signal and/or a PRACH power calculated based on the path loss.

The terminal device may calculate a transmit power based on open-loop power control. If the calculated transmit power is less than the maximum transmit power, the PRACH is transmitted by using the calculated transmit power. In this embodiment of this application, a larger PRACH transmit power calculated based on open-loop power control indicates poorer coverage at a location of the terminal device, and indicates larger transmit power required by the terminal device for transmitting the PRACH, to meet a target received power requirement. Therefore, a PRACH transmit power threshold (referred to as a first threshold) may be set in this embodiment of this application. If the calculated transmit power is greater than or equal to the first threshold or if the calculated transmit power reaches or satisfies the first threshold, the terminal device may perform the second-type PRACH transmission. Setting a proper first threshold can reduce power waste of the terminal device and interference caused by the terminal device.

In some embodiments, the first threshold is less than the maximum transmit power. In some embodiments, the first threshold may be determined based on the maximum transmit power. For example, the first threshold may be obtained by subtracting an offset value from the maximum transmit power. A size of the offset value is not specifically limited in embodiments of this application. For example, the offset value may be a value ranging from 1 dB to 3 dB. The terminal device may determine the first threshold based on the offset value and the maximum transmit power. In some other embodiments, the first threshold may be a specific value measured in dBm. For ease of description, at least one of the first threshold or the offset value is referred to as configuration information of the first threshold.

The configuration information of the first threshold may be predefined in a protocol or may be indicated by the network device to the terminal device. For example, the network device may indicate configuration information of the first threshold through a system message.

In some embodiments, configuration of the configuration information of the first threshold is optional. For example, the network device may configure the configuration information of the first threshold for the terminal device, or may not configure the configuration information of the first threshold for the terminal device. If the network device has configured the configuration information of the first threshold, the terminal device may determine, based on the first threshold, whether to perform the second-type PRACH transmission. If the network device has not configured the configuration information of the first threshold for the terminal device, the terminal device may not determine, based on the first threshold, whether to perform the second-type PRACH transmission. In this case, the terminal device may not perform the second-type PRACH transmission, or the terminal device may determine, based on another condition, whether to perform PRACH transmission. For example, the terminal device may determine, based on the maximum transmit power (such as Condition 1 described above), whether to perform the second-type PRACH transmission, or the terminal device may determine, based on the quantity of transmissions (such as Condition 3 described below), whether to perform the second-type PRACH transmission.

In some embodiments, in each PRACH transmission, the terminal device may first calculate a required power based on the first-type PRACH transmission, and compare the calculated power with the first threshold. If the calculated power is less than the first threshold, the first-type PRACH transmission is performed. If the calculated power is greater than or equal to the first threshold, the second-type PRACH transmission is performed.

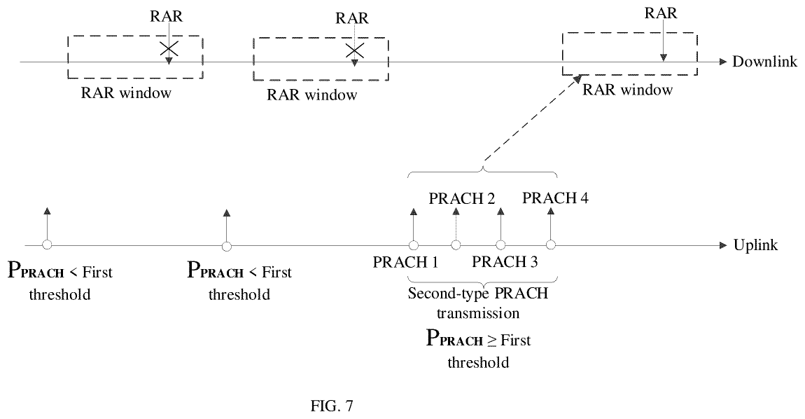

The following describes a PRACH transmission process with reference to FIG. 7.

When performing a 1^{st} PRACH transmission, the terminal device may first calculate the required transmit power according to Formula (1). Because the calculated transmit power is less than the first threshold, the terminal device performs the first-type PRACH transmission. If the terminal device has not detected, in a RAR window corresponding to the 1^{st} PRACH transmission, a RAR transmitted by the network device, the terminal device performs a 2^{nd} PRACH transmission. The terminal device recalculates the transmit power according to Formula (1), that is, increases the transmit power of the PRACH. Because the calculated transmit power is less than the first threshold, the terminal device performs the first-type PRACH transmission. If the terminal device has not detected, in a RAR window corresponding to the 2^{nd} PRACH transmission, a RAR transmitted by the network device, the terminal device performs a 3^{rd} PRACH transmission. The terminal device recalculates the transmit power according to Formula (1), that is, increases the transmit power of the PRACH. Because the transmit power calculated for the third time is greater than or equal to the first threshold, the condition for performing the second-type PRACH transmission is met, and the terminal device performs the second-type PRACH transmission. The terminal device may transmit a plurality of PRACHs during the 3^{rd} PRACH transmission. As shown in FIG. 7, the terminal device may send four PRACHs during the 3^{rd} PRACH transmission process. The four PRACHs correspond to one RAR window, and the terminal device may detect, in the RAR window, a RAR transmitted by the network device.

Condition 3: The Quantity of Transmissions Corresponding to the First-Type PRACH Transmission is Greater than or Equal to the Second Threshold

In some embodiments, Condition 3 may also be: the quantity of transmissions corresponding to the first-type PRACH transmission reaches or satisfies the second threshold. For example, Condition 3 may be: the quantity of transmissions corresponding to the first-type PRACH transmission equal to the second threshold.

It can be learned from the foregoing description that a transmit power of a PRACH may be determined based on a target received power, a path loss, a quantity of PRACH power ramp-up times, and a step that are configured by a higher layer. PREAMBLE_POWER_RAMPING_COUNTER is used to count a quantity of PRACH transmissions, thereby determining a quantity of PRACH power ramping steps. Therefore, more PRACH transmissions indicate a larger PRACH transmit power of the terminal device, and poorer coverage at the location of the terminal device.

In some embodiments, whether to perform the second-type PRACH transmission may be determined based on the quantity of PRACH transmissions. For example, if the quantity of PRACH transmissions is greater than or equal to the second threshold, or if the quantity of PRACH transmissions reaches or satisfies the second threshold, the terminal device may perform the second-type PRACH transmission. In this embodiment of this application, setting a proper second threshold can reduce power waste of the terminal device and interference caused by the terminal device.

In some embodiments, the second threshold may be predefined in a protocol or may be indicated by the network device to the terminal device. For example, the network device may indicate the second threshold through a system message.

In some embodiments, configuration of the second threshold is optional. For example, the network device may configure the second threshold for the terminal device, or may not configure the second threshold for the terminal device. If the network device has configured the second threshold, the terminal device may determine, based on the second threshold, whether to perform the second-type PRACH transmission. If the network device has not configured the second threshold for the terminal device, the terminal device may not determine, based on the second threshold, whether to perform the second-type PRACH transmission. In some embodiments, if the network device has not configured the second threshold for the terminal device, the terminal device may not perform the second-type PRACH transmission, or the terminal device may determine, based on another condition, whether to perform PRACH transmission. For example, the terminal device may determine, based on the maximum transmit power (such as Condition 1 described above), whether to perform the second-type PRACH transmission, or the terminal device may determine, based on the first threshold (such as Condition 2 described above), whether to perform the second-type PRACH transmission.

In some embodiments, in each PRACH transmission, the terminal device may compare the current quantity of transmissions with the second threshold. If the quantity of transmissions is less than the second threshold, the first-type PRACH transmission is performed. If the quantity of transmissions is greater than or equal to the second threshold, or the quantity of transmissions reaches or satisfies the second threshold, the second-type PRACH transmission is performed. If the quantity of transmissions is greater than or equal to the second threshold, the terminal device may perform the second-type PRACH transmission during a current or next PRACH transmission process. For example, if a value of the second threshold is 2, the terminal device may perform the second-type PRACH transmission during a 2^{nd} PRACH transmission process. Alternatively, the terminal device may still perform the first-type PRACH transmission during the 2^{nd} PRACH transmission process, but may perform the second-type PRACH transmission during a 3^{rd} PRACH transmission process.

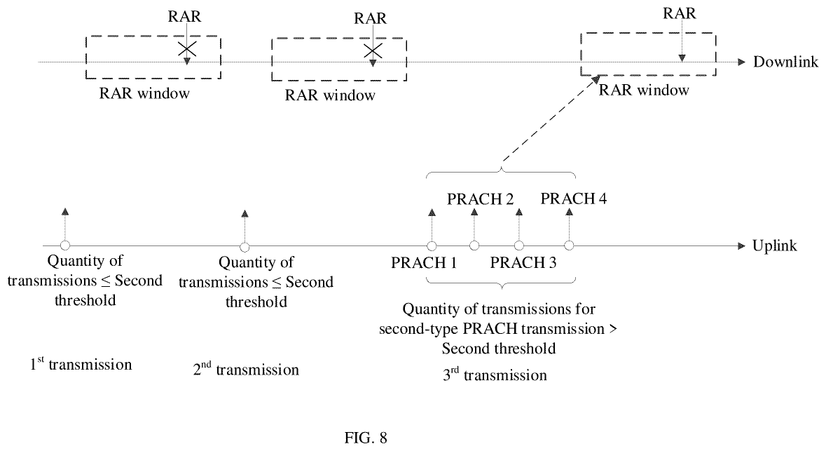

The following describes a PRACH transmission process with reference to FIG. 8 by using an example in which the second-type PRACH transmission is performed in a next transmission process when Condition 3 is met.

Assuming that the value of the second threshold is 2, the terminal device may perform the first-type PRACH transmission during the first two PRACH transmissions, and perform the second-type PRACH transmission during the 3^{rd} PRACH transmission. The terminal device may send a plurality of PRACHs during the 3^{rd} PRACH transmission. As shown in FIG. 8, the terminal device may transmit four PRACHs during the 3^{rd} PRACH transmission process. The four PRACHs correspond to one RAR window, and the terminal device may detect, in the RAR window, a RAR transmitted by the network device.

The plurality of conditions described above may be used alone or in combination with each other, which is not specifically limited in embodiments of this application. In an example, Condition 1, Condition 2, and Condition 3 may be used separately, and the terminal device may determine whether to perform the second-type PRACH transmission based on any one of Condition 1, Condition 2, or Condition 3. In another example, Condition 1, Condition 2, and Condition 3 may be used in combination with each other. For example, Condition 1 and Condition 3 may be combined with each other, and Condition 2 and Condition 3 may be combined with each other. If Condition 1 and Condition 3 are combined with each other, the terminal device may perform the second-type PRACH transmission when both Condition 1 and Condition 3 are met, or the terminal device may perform the second-type PRACH transmission when either Condition 1 or Condition 3 is met. If Condition 2 and Condition 3 are combined with each other, the terminal device may perform the second-type PRACH transmission when both Condition 2 and Condition 3 are met, or the terminal device may perform the second-type PRACH transmission when either Condition 2 or Condition 3 is met.

In this embodiment of this application, a condition for switching from the first-type PRACH transmission to the second-type PRACH transmission is emphasized. How to perform the second-type PRACH transmission after switching to the second-type PRACH transmission, a quantity of transmissions for the second-type PRACH transmission, or whether it is necessary to switch to the first-type PRACH transmission again is not specifically limited in embodiments of this application.

In an example, after switching to the second-type PRACH transmission, the terminal device may perform the second-type PRACH transmission until random access fails (that is, the quantity of transmissions reaches the maximum quantity of transmissions and the RAR transmitted by the network device is not received), or random access succeeds.

In another example, the terminal device may perform the second-type PRACH transmissions for a preset quantity of times after switching to the second-type PRACH transmission. When the quantity of times for the second-type PRACH transmission reaches the preset quantity, the terminal device may switch to first-type PRACH transmissions.

In another example, after switching to the second-type PRACH transmission, the terminal device may switch to the first-type PRACH transmission when the transmit power of the PRACH reaches the target transmit power.

A condition for starting the first-type PRACH transmission is not specifically limited in embodiments of this application. For example, the terminal device may directly use the first-type PRACH transmission during initial PRACH transmission. For another example, the terminal device may first determine whether an initial condition for directly performing the second-type PRACH transmission is met. If the initial condition is not met, the terminal device may first perform the first-type PRACH transmission. It should be noted that the initial condition is different from those described above.

The condition for switching from the first-type PRACH transmission to the second-type PRACH transmission is described above. The following describes the transmit power corresponding to the second-type PRACH transmission.

The transmit power corresponding to the second-type PRACH transmission may be understood as a transmit power used for performing the second-type PRACH transmission. For ease of description, the transmit power corresponding to the second-type PRACH transmission is referred to as a second power below.

One transmission process of the second-type PRACH transmission includes a plurality of PRACH transmissions, and the second power may be a transmit power of any one of the plurality of PRACH transmissions (for example, a transmit power of any one of PRACH 1 to PRACH 4 in FIG. 6 to FIG. 8). For example, the second power may be a transmit power of a PRACH with an earliest transmission time in the plurality of PRACH transmissions (for example, the transmit power of PRACH 1 in FIG. 6 to FIG. 8), and the transmit power of the PRACH with the earliest transmission time may be understood as the 1^{st} PRACH transmission in the plurality of PRACH transmissions. Certainly, the second power may alternatively be a transmit power of another PRACH in the plurality of PRACH transmissions, such as a transmit power of a PRACH with the latest transmission time (for example, the transmit power of PRACH 4 in FIG. 6 to FIG. 8).

The transmit powers of the plurality of PRACH transmissions may be equal or not equal to each other. The transmit powers of plurality of PRACH transmissions being not equal to each other may include that any two of transmit powers of the plurality of PRACH transmissions are not equal to each other, or that some transmit powers of the plurality of PRACH transmissions are not equal to each other.

If the transmit powers of the plurality of PRACH transmissions are equal to each other, the transmit powers of the plurality of PRACH transmissions may all be the second power. For another example, if the transmit powers of the plurality of PRACH transmissions are not equal to each other, the second power may be a transmit power of a specific PRACH transmission in the plurality of PRACH transmissions. A transmit power of another PRACH transmission in the plurality of PRACH transmissions may be determined based on the second power. The second power being a transmit power of the 1^{st} PRACH transmission in the plurality of PRACH transmissions is used as an example, and a transmit power of another PRACH transmission may be increased on the basis of the second power. FIG. 6 to FIG. 8 are used as an example, and the second power is the transmit power of PRACH 1. The transmit power of PRACH 2 may be a power increased on the basis of the second power (denoted as power a). The transmit power of PRACH 3 may be a power increased on the basis of power a (denoted as power b). The transmit power of PRACH 4 may be a power increased based on power b. A step for the increase may be the same as or different from that in a conventional technology. This is not specifically limited in embodiments of this application.

The second power may be determined based on the first power, the first power may be determined based on the transmit power corresponding to the first-type PRACH transmission, or the first power may be determined based on the maximum transmit power of the terminal device.

The transmit power corresponding to the first-type PRACH transmission may refer to a transmit power corresponding to any PRACH transmission in the first-type PRACH transmission.

In some embodiments, the first power may be determined based on a transmit power corresponding to a last transmission in the first-type PRACH transmission. For ease of description, the transmit power corresponding to the last transmission in the first-type PRACH transmission is referred to as a last transmit power, and the last transmission in the first-type PRACH transmission is referred to as a last transmission. For example, the first power may be equal to the last transmit power. FIG. 6 to FIG. 8 are used as an example, and the last transmit power is a power used for the 2^{nd} PRACH transmission. It may be understood that in a next transmission following the last transmission, the terminal device performs the second-type PRACH transmission.

In some embodiments, the first power may be greater than the last transmit power, so that the terminal device can perform the second-type PRACH transmission with a larger power to further improve PRACH coverage.

In some embodiments, the first power may be determined based on a transmit power corresponding to the first PRACH transmission when the condition is met. In other words, the first power may be determined based on a transmit power corresponding to an (N+1)^{th} PRACH transmission, where N represents a total quantity of transmissions corresponding to the first-type PRACH transmissions. An N^{th} transmission may be understood as the last transmission in the first-type PRACH transmission. That is, the first power may be determined based on a transmit power that is used for a next transmission following the last transmission and that corresponds to the first-type PRACH transmission. For example, the first power may be equal to the transmit power corresponding to the (N+1)^{th} transmission. The following describes, reference to the foregoing Conditions 1 to 3, manners of determining the first power by examples.

For Condition 1, reference is made to FIG. 6. During the 3^{rd} PRACH transmission, the terminal device first calculates a power corresponding to the first-type PRACH transmission. Because the power is equal to the maximum transmit power P_{CMAX,f,c} (i), the terminal device may perform the second-type PRACH transmission. In this embodiment of this application, the first power may be determined based on the maximum transmit power P_{CMAX,f,c} (i), that is, the second power of the second-type PRACH transmission may be determined based on the maximum transmit power P_{CMAX,f,c} (i).

For Condition 2, reference is made to FIG. 7. During the 3^{rd} PRACH transmission, the terminal device first calculates the power (referred to as calculated power for short) corresponding to the first-type PRACH transmission. Because the calculated power is greater than or equal to the first threshold, the terminal device may perform the second-type PRACH transmission. In this embodiment of this application, the first power may be determined based on the calculated power, that is, the second power of the second-type PRACH transmission may be determined based on the calculated power.

For Condition 3, reference is made to FIG. 8, during the 3^{rd} PRACH transmission performed by the terminal device, because the quantity of transmissions is greater than the second threshold, the terminal device performs the second-type PRACH transmission. In this embodiment of this application, the first power may be determined based on a transmit power corresponding to the 3^{rd} PRACH transmission. The terminal device may calculate, based on the first-type PRACH transmission, the transmit power corresponding to the 3^{rd} PRACH transmission.

In some embodiments, if the terminal device performs the second-type PRACH transmission in a current transmission when the condition is met, a transmission that meets the condition is a next transmission following the last transmission. If the terminal device performs the second-type PRACH transmission in a next transmission when the condition is met, a transmission that meets the condition is the same transmission as the last transmission.

In some embodiments, regardless of which of the foregoing conditions is used, the terminal device may determine the second power based on the maximum transmit power. That is, regardless of which of the foregoing Conditions 1 to 3 is used as the determination condition, the terminal device may determine the second power based on the maximum transmit power.

In some embodiments, the second power may be equal to the first power, or the second power may be determined based on an adjusted first power.

For the second-type PRACH transmission, the network device can improve PRACH detection performance by performing combined reception. That is, the second-type PRACH transmission can improve PRACH coverage to a certain extent. Therefore, in this embodiment of this application, the first power may be adjusted and the second power may be determined based on an adjusted first power. In an example, the second power may be determined based on the first power and a power offset. The power offset may be greater than 0 or less than 0. In some embodiments, the second power may be a sum of the first power and the power offset. For example, Second power=First power+Power offset. Certainly, in some embodiments, Second power=First power−Power offset.

In some embodiments, the power offset may be determined based on a quantity of PRACHs included in one transmission process of the second-type PRACH transmission. For example, if one transmission process includes more PRACHs, a value of the power offset may be larger; if one transmission process includes fewer PRACHs, a value of the power offset may be smaller.

In some embodiments, the first power may be the maximum transmit power of the terminal device. The terminal device may subtract a first offset value (such as 1 dB) from the maximum transmit power to obtain the second power. Condition 1 is used as an example, and the terminal device may subtract the first offset value from the maximum transmit power, and use a calculated value as the transmit power for performing the second-type PRACH transmission.

In some embodiments, Condition 2 and Condition 3 are used as an example, and the first power may be power calculated by using open-loop power control (referred to as open-loop power). In this case, the terminal device may apply a second offset based on the open-loop power to obtain the second power.

For example, the second power may be determined based on the following formula:

P_{PRACH,b,f,c}(i)=min{P_{CMAX,f,c}(i),P_{PRACH,target,f,c}+PL_{b,f,c}+α}

Herein, α is a second offset value. α may be greater than 0 or less than 0.

The second offset value may be greater than 0 or less than 0, which is not specifically limited in embodiments of this application.

In some embodiments, the second power may be determined based on the following formula:

P_{RACH,b,f,c}(i)=min{P_{CMAX,f,c}(i), min{P_{CMAX,f,c}(i),P_{PRACH,target,f,c}+PL_{b,f,c}}+β}

Herein, β represents an offset value. β may be greater than 0 or less than 0. This formula is applicable to the foregoing Conditions 1 to 3.

In a conventional random access procedure, the network device configures a maximum quantity of PRACH transmissions for the terminal device. When the quantity of PRACH transmissions reaches the maximum quantity of transmissions and the RAR transmitted by the network device is still not received, the terminal device may determine that the current random access fails. A manner of configuring the maximum quantity of transmissions by the network device is not specifically limited in embodiments of this application. For example, the network device may configure the maximum quantity of transmissions by using an information element preambleTransMax. Values of preambleTransMax include 3, 4, 5, 6, 7, 8, 10, 20, 50, 100, and 200.

The quantity of transmissions performed by the terminal device may be counted by a counter (PREAMBLE_POWER_RAMPING_COUNTER). Each time the terminal device performs one PRACH transmission, the counter increases by 1. When a value of the counter reaches the maximum quantity of transmissions and the RAR transmitted by the network device is still not received, the terminal device may determine that the current random access fails.

In this embodiment of this application, the second-type PRACH transmission is triggered only when a particular condition is met, that is, the terminal device may first perform the first-type PRACH transmission and then perform the second-type PRACH transmission. Specifically, during an entire random access procedure, the terminal device first performs the first-type PRACH transmission one or more times, and then perform the second-type PRACH transmission when a particular condition is met. There is currently no clear approach for defining a maximum quantity of transmissions for a random access procedure including two types of PRACH transmissions.

Based on this, embodiments of this application provide two manners for specifying the maximum quantity of transmissions, and these two manners are described below separately.

Manner 1: The quantity of transmissions for the first-type PRACH transmission and the quantity of transmissions for the second-type PRACH transmission are counted together. The first-type PRACH transmission and the second-type PRACH transmission correspond to a same counter. That is, a sum of quantities of transmissions for the first-type PRACH transmission and the second-type PRACH transmission corresponds to a maximum quantity of transmissions. Each time the terminal device performs the first-type PRACH transmission, the counter increases by 1. Each time the terminal device performs the second-type PRACH transmission, the counter also increases by 1. When a total count value of the counter reaches the maximum quantity of transmissions preambleTransMax and the RAR transmitted by the network device is still not received, the terminal device may determine that the random access fails.

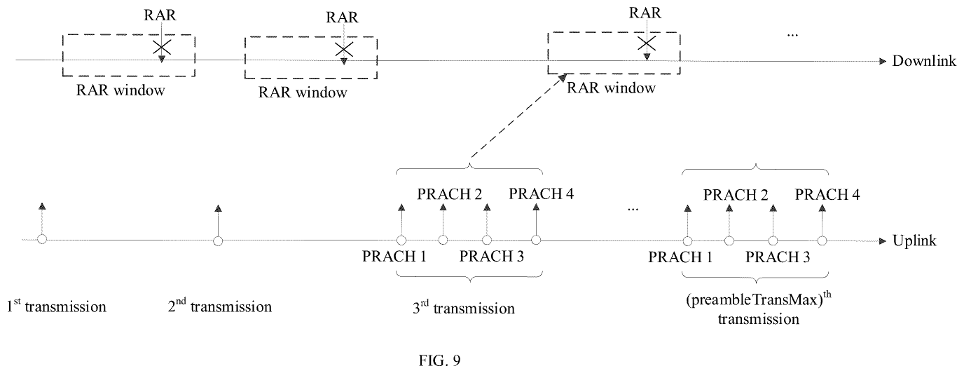

The following describes a manner of counting PRACH transmissions with reference to FIG. 9.

The first two transmissions of the random access procedure shown in FIG. 9 are first-type PRACH transmission, and a subsequent transmission is second-type PRACH transmission. Because the first-type PRACH transmission and the second-type PRACH transmission are counted together, the 1^{st} second-type PRACH transmission may be referred to as the 3^{rd} transmission.

Manner 2: The quantity of transmissions for the first-type PRACH transmission and the quantity of transmissions for the second-type PRACH transmission are counted separately. The first-type PRACH transmission and the second-type PRACH transmission correspond to different counters. In the following, a counter corresponding to the first-type PRACH transmission is referred to as counter 1, and a counter corresponding to the second-type PRACH transmission is referred to as counter 2. The first-type PRACH transmission and the second-type PRACH transmission each correspond to a maximum quantity of transmissions. The first-type PRACH transmission corresponds to one maximum quantity of transmissions (denoted as preambleTransMax 1), and the second-type PRACH transmission corresponds to another maximum quantity of transmissions (denoted as preambleTransMax 2). preambleTransMax 1 and preambleTransMax 2 may be equal or not equal to each other.

The first-type PRACH transmission is counted separately. The network device may configure a maximum quantity of transmissions preambleTransMax 1 for the first-type PRACH transmission. Each time the terminal device performs the first-type PRACH transmission, counter 1 increases by 1. When a value of counter 1 reaches the maximum quantity of transmissions preambleTransMax 1 and the RAR transmitted by the network device is still not received, the terminal device may determine that the random access fails.

The second-type PRACH transmission is counted separately. The network device may configure a maximum quantity of transmissions preambleTransMax 2 for the second-type PRACH transmission. Each time the terminal device performs the second-type PRACH transmission, counter 2 increases by 1. When a value of counter 2 reaches the maximum quantity of transmissions preambleTransMax 2 and the RAR transmitted by the network device is still not received, the terminal device may determine that the random access fails.

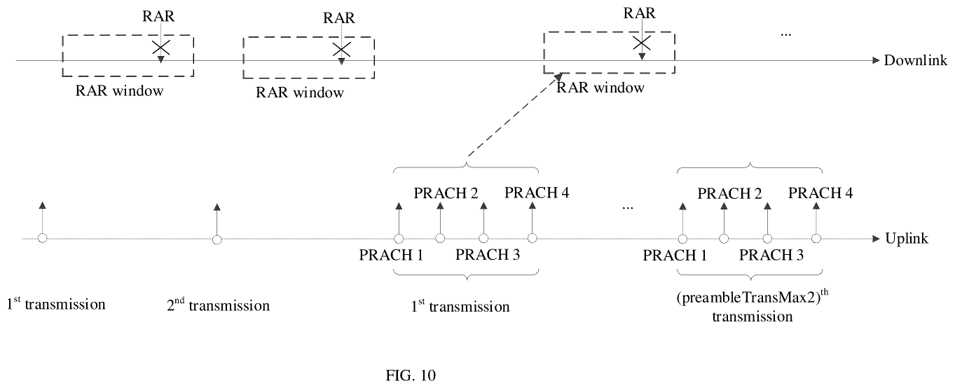

The following describes a manner of counting PRACH transmissions with reference to FIG. 10.

The first two transmissions of the random access procedure shown in FIG. 10 are first-type PRACH transmission, and a subsequent transmission is second-type PRACH transmission. Because the first-type PRACH transmission and the second-type PRACH transmission are counted separately, the 1^{st} second-type PRACH transmission may be referred to as the 1^{st} transmission.

The method embodiments of this application are described in detail above with reference to FIG. 1 to FIG. 10. Apparatus embodiments of this application are described in detail below with reference to FIG. 11 and FIG. 13. It should be understood that the description of the method embodiments corresponds to the description of the apparatus embodiments, and therefore, for parts that are not described in detail, reference may be made to the foregoing method embodiments.

FIG. 11 is a schematic diagram of a terminal device according to an embodiment of this application. The terminal device 1100 may be any terminal device described above. The terminal device 1100 may include a transmission unit 1110.

The transmission unit 1110 is configured to: if a transmission parameter corresponding to first-type PRACH transmission meets a condition, perform second-type PRACH transmission, where one transmission process of the first-type PRACH transmission includes one PRACH transmission, and one transmission process of the second-type PRACH transmission includes a plurality of PRACH transmissions.

In some embodiments, the transmission parameter includes one or more of the following information: a transmit power, a quantity of transmissions, or a downlink path loss.

In some embodiments, the condition includes one or more of the following: a transmit power corresponding to the first-type PRACH transmission reaches a maximum transmit power of the terminal device; a transmit power corresponding to the first-type PRACH transmission is greater than or equal to a first threshold; or a quantity of transmissions corresponding to the first-type PRACH transmission is greater than or equal to a second threshold.

In some embodiments, a transmit power corresponding to the second-type PRACH transmission is determined based on a first power, and the first power is determined based on a transmit power corresponding to the first-type PRACH transmission or the maximum transmit power of the terminal device.

In some embodiments, the first power is determined based on one or more of the following: a transmit power corresponding to a last transmission in the first-type PRACH transmission; or a transmit power corresponding to the first-type PRACH transmission when the condition is met.

In some embodiments, the transmit power corresponding to the second-type PRACH transmission is a transmit power of any one of the plurality of PRACH transmissions.

In some embodiments, the transmit power corresponding to the second-type PRACH transmission is a transmit power of a PRACH with an earliest transmission time in the plurality of PRACH transmissions.

In some embodiments, the transmit power corresponding to the second-type PRACH transmission is determined based on the first power and a power offset.

In some embodiments, the transmit power corresponding to the second-type PRACH transmission is a sum of the first power and the power offset.

In some embodiments, a quantity of transmissions for the first-type PRACH transmission and a quantity of transmissions for the second-type PRACH transmission are counted together; or a quantity of transmissions for the first-type PRACH transmission and a quantity of transmissions for the second-type PRACH transmission are counted separately.

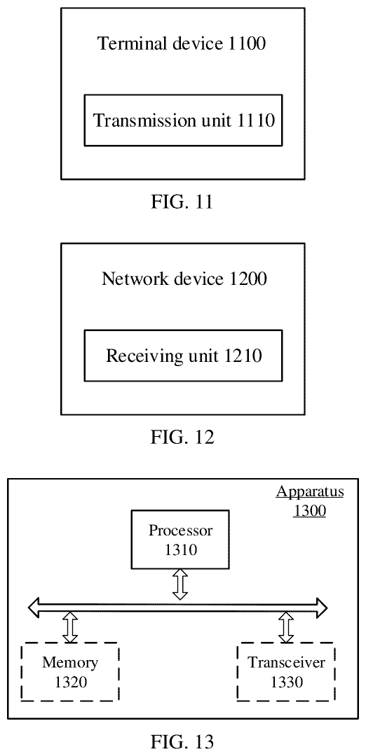

FIG. 12 is a schematic diagram of a network device according to an embodiment of this application. The network device 1200 may be any network device described above. The network device 1200 may include a receiving unit 1210.

The receiving unit 1210 is configured to: if a transmission parameter corresponding to first-type physical random access channel PRACH transmission meets a condition, receive a PRACH transmitted by using a manner of second-type PRACH transmission, where one transmission process of the first-type PRACH transmission includes one PRACH transmission, and one transmission process of the second-type PRACH transmission includes a plurality of PRACH transmissions.

In some embodiments, the transmission parameter includes one or more of the following information: a transmit power, a quantity of transmissions, or a downlink path loss.

In some embodiments, the condition includes one or more of the following: a transmit power corresponding to the first-type PRACH transmission reaches a maximum transmit power of the terminal device; a transmit power corresponding to the first-type PRACH transmission is greater than or equal to a first threshold; or a quantity of transmissions corresponding to the first-type PRACH transmission is greater than or equal to a second threshold.

In some embodiments, a transmit power corresponding to the second-type PRACH transmission is determined based on a first power, and the first power is determined based on the transmit power corresponding to the first-type PRACH transmission or the maximum transmit power of the terminal device.

In some embodiments, the first power is determined based on one or more of the following: a transmit power corresponding to a last transmission in the first-type PRACH transmission; or a transmit power corresponding to the first-type PRACH transmission when the condition is met.

In some embodiments, the transmit power corresponding to the second-type PRACH transmission is a transmit power of any one of the plurality of PRACH transmissions.

In some embodiments, the transmit power corresponding to the second-type PRACH transmission is a transmit power of a PRACH with an earliest transmission time in the plurality of PRACH transmissions.

In some embodiments, the transmit power corresponding to the second-type PRACH transmission is determined based on the first power and a power offset.

In some embodiments, the transmit power corresponding to the second-type PRACH transmission is a sum of the first power and the power offset.

In some embodiments, a quantity of transmissions for the first-type PRACH transmission and a quantity of transmissions for the second-type PRACH transmission are counted together; or a quantity of transmissions for the first-type PRACH transmission and a quantity of transmissions for the second-type PRACH transmission are counted separately.

FIG. 13 is a schematic diagram of a structure of a communication apparatus according to an embodiment of this application. The dashed lines in FIG. 13 indicate that the unit or module is optional. The apparatus 1300 may be configured to implement the methods described in the foregoing method embodiments. The apparatus 1300 may be a chip, a terminal device, or a network device.

The apparatus 1300 may include one or more processors 1310. The processor 1310 may allow the apparatus 1300 to implement the methods described in the foregoing method embodiments. The processor 1310 may be a general-purpose processor or a dedicated processor. For example, the processor may be a central processing unit (CPU). Alternatively, the processor may be another general-purpose processor, a digital signal processor (digital signal processor, DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1300 may further include one or more memories 1320. The memory 1320 stores a program that may be executed by the processor 1310, so that the processor 1310 performs the method described in the foregoing method embodiments. The memory 1320 may be separate from the processor 1310 or may be integrated into the processor 1310.

The apparatus 1300 may further include a transceiver 1330. The processor 1310 may communicate with another device or chip through the transceiver 1330. For example, the processor 1310 may transmit data to and receive data from another device or chip by using the transceiver 1330.

An embodiment of this application further provides a computer-readable storage medium for storing a program. The computer-readable storage medium may be applied to the terminal or network device provided in embodiments of this application, and the program causes a computer to perform the method performed by the terminal or network device in various embodiments of this application.

An embodiment of this application further provides a computer program product. The computer program product includes a program. The computer program product may be applied to the terminal or network device provided in embodiments of this application, and the program causes a computer to perform the method performed by the terminal or network device in various embodiments of this application.

An embodiment of this application further provides a computer program. The computer program may be applied to the terminal or network device provided in embodiments of this application, and the computer program causes a computer to perform the methods performed by the terminal or the network device in various embodiments of this application.

It should be understood that the terms “system” and “network” in this application may be used interchangeably. In addition, the terms used in this application are only used to explain the specific embodiments of this application, and are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indicate” mentioned herein may refer to a direct indication, or may refer to an indirect indication, or may mean that there is an association. For example, A indicates B, which may mean that A directly indicates B, for example, B may be obtained by means of A; or may mean that A indirectly indicates B, for example, A indicates C, and B may be obtained by means of C; or may mean that there is an association between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association between the two, or may mean that there is a relationship such as indicating and being indicated, or configuring and being configured.

In embodiments of this application, “predefined” or “pre-configured” may be implemented by pre-storing corresponding code, tables, or other forms that may be used to indicate related information in devices (for example, including a terminal device and a network device), and a specific implementation thereof is not limited in this application. For example, being pre-defined may refer to being defined in a protocol.

In embodiments of this application, the “protocol” may refer to a standard protocol in the communications field, and may include, for example, an LTE protocol, an NR protocol, and a related protocol applied to a future communication system, which is not limited in this application.

In embodiments of this application, the term “and/or” is merely an association that describes associated objects, and represents that there may be three relationships. For example, A and/or B may represent three cases: only A exists, both A and B exist, and only B exists. In addition, the character “/” in the specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatus or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual requirements to achieve the objectives of the solutions of embodiments.

In addition, functional units in embodiments of this application may be integrated into one processing unit, each of the units may exist alone physically, or two or more units are integrated into one unit.

All or some of the foregoing embodiments may be implemented by using software, hardware, firmware, or any combination thereof. When software is used for implementation, the method may be implemented completely or partially in the form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A terminal device, comprising at least one processor, wherein the at least one processor is configured to:
if a transmission parameter corresponding to first-type physical random access channel PRACH transmission meets a condition, perform second-type PRACH transmission, wherein one transmission process of the first-type PRACH transmission comprises one PRACH transmission, and one transmission process of the second-type PRACH transmission comprises a plurality of PRACH transmissions.

2. The terminal device according to claim 1, wherein the transmission parameter comprises one or more of following information: a transmit power, a quantity of transmissions, or a downlink path loss.

3. The terminal device according to claim 2, wherein the condition comprises one or more of following:
a transmit power corresponding to the first-type PRACH transmission reaches a maximum transmit power of the terminal device;
a transmit power corresponding to the first-type PRACH transmission is greater than or equal to a first threshold; or
a quantity of transmissions corresponding to the first-type PRACH transmission is greater than or equal to a second threshold.

4. The terminal device according to claim 1, wherein a transmit power corresponding to the second-type PRACH transmission is determined based on a first power, and the first power is determined based on a transmit power corresponding to the first-type PRACH transmission or the maximum transmit power of the terminal device.

5. The terminal device according to claim 4, wherein the first power is determined based on one or more of following:
a transmit power corresponding to a last transmission in the first-type PRACH transmission; or
a transmit power corresponding to the first-type PRACH transmission when the condition is met.

6. The terminal device according to claim 4, wherein the transmit power corresponding to the second-type PRACH transmission is a transmit power of any one of the plurality of PRACH transmissions.

7. The terminal device according to claim 6, wherein the transmit power corresponding to the second-type PRACH transmission is a transmit power of a PRACH with an earliest transmission time in the plurality of PRACH transmissions.

8. The terminal device according to claim 4, wherein the transmit power corresponding to the second-type PRACH transmission is determined based on the first power and a power offset.

9. The terminal device according to claim 8, wherein the transmit power corresponding to the second-type PRACH transmission is a sum of the first power and the power offset.

10. The terminal device according to claim 1, wherein a quantity of transmissions for the first-type PRACH transmission and a quantity of transmissions for the second-type PRACH transmission are counted together; or
the quantity of transmissions for the first-type PRACH transmission and a quantity of transmissions for the second-type PRACH transmission are counted separately.

11. A network device, comprising at least one processor, wherein the at least one processor is configured to:
if a transmission parameter corresponding to first-type physical random access channel PRACH transmission meets a condition, receive a PRACH transmitted by using a manner of second-type PRACH transmission, wherein one transmission process of the first-type PRACH transmission comprises one PRACH transmission, and one transmission process of the second-type PRACH transmission comprises a plurality of PRACH transmissions.

12. The network device according to claim 11, wherein the transmission parameter comprises one or more of following information: a transmit power, a quantity of transmissions, or a downlink path loss.

13. The network device according to claim 12, wherein the condition comprises one or more of following:
a transmit power corresponding to the first-type PRACH transmission reaches a maximum transmit power of the terminal device;
a transmit power corresponding to the first-type PRACH transmission is greater than or equal to a first threshold; or
a quantity of transmissions corresponding to the first-type PRACH transmission is greater than or equal to a second threshold.

14. The network device according to claim 11, wherein a transmit power corresponding to the second-type PRACH transmission is determined based on a first power, and the first power is determined based on a transmit power corresponding to the first-type PRACH transmission or the maximum transmit power of the terminal device.

15. The network device according to claim 14, wherein the first power is determined based on one or more of following:
a transmit power corresponding to a last transmission in the first-type PRACH transmission; or
a transmit power corresponding to the first-type PRACH transmission when the condition is met.

16. The network device according to claim 11, wherein a quantity of transmissions for the first-type PRACH transmission and a quantity of transmissions for the second-type PRACH transmission are counted together; or
a quantity of transmissions for the first-type PRACH transmission and a quantity of transmissions for the second-type PRACH transmission are counted separately.

17. A wireless communication method, comprising:
if a transmission parameter corresponding to first-type physical random access channel PRACH transmission meets a condition, performing, by a terminal device, second-type PRACH transmission, wherein one transmission process of the first-type PRACH transmission comprises one PRACH transmission, and one transmission process of the second-type PRACH transmission comprises a plurality of PRACH transmissions.

18. The method according to claim 17, wherein the transmission parameter comprises one or more of following information: a transmit power, a quantity of transmissions, or a downlink path loss.

19. The method according to claim 18, wherein the condition comprises one or more of following:
a transmit power corresponding to the first-type PRACH transmission reaches a maximum transmit power of the terminal device;
a transmit power corresponding to the first-type PRACH transmission is greater than or equal to a first threshold; or
a quantity of transmissions corresponding to the first-type PRACH transmission is greater than or equal to a second threshold.

20. The method according to claim 17, wherein a quantity of transmissions for the first-type PRACH transmission and a quantity of transmissions for the second-type PRACH transmission are counted together, or
the quantity of transmissions for the first-type PRACH transmission and a quantity of transmissions for the second-type PRACH transmission are counted separately.
